(19) United States
(12) Patent Application Publication
(10) Pub. No.: US 2023/0078577 A1
(43) Pub. Date: Mar. 16, 2023

(54) QUERY RESULT SET PROCESSING

(71) Applicant: International Business Machines Corporation, Armonk, NY (US)

(72) Inventors: Sheng Yan Sun, Beijing (CN); Shuo Li, Beijing (CN); Xiaobo Wang, Beijing (CN); Peng Hui Jiang, Beijing (CN)

(21) Appl. No.: 17/447,646

(22) Filed: Sep. 14, 2021

(51) Int. Cl. G06F 16/2455; G06F 7/14

(52) U.S. Cl. CPC G06F 16/24556; G06F 7/14

(57) ABSTRACT

A computer implemented method processes a search query from a requestor. A number of processor units selects an access path from access paths for each database in a set of databases based on reducing a cost for searching the set of databases using a set of access paths selected for the set of databases in response to receiving the search query from a requestor. The number of processor units receives a result set from searching the set of databases using the set of access paths selected for the set of databases. The number of processor units removes a number of duplicate records from records in the result set. The number of processor units sends the result set with the number of duplicate records removed to the requestor.

### BACKGROUND

### 1. Field

The disclosure relates generally to an improved computer system and, more specifically, to processing search results to reduce duplicated results returned from a search query.

### 2. Description of the Related Art

Users commonly search databases to obtain information. For example, the user may search for information about a type of car, a company, or some other information using a search engine. Searches can also be performed to obtain files such as those for the video, spreadsheet, a document, or other type of file. Users may also perform searches to purchase goods or services.

Often, the search is performed by a user operating a web browser that submits the search query over the Internet to a search engine that can search one or more databases. The search engine for a database can perform searches using the search query directly or indirectly using indexes for the databases. The results identified by the search engine are returned as a list of results. This list can be in a webpage for the user to review. The user can review the items on the webpage representing the search results and selected links for the items to obtain more detailed information.

### SUMMARY

According to one illustrative embodiment, a computer implemented method processes a search query. A number of processor units selects an access path from access paths for each database in a set of databases based on reducing a cost for searching the set of databases using a set of access paths selected for the set of databases in response to receiving the search query from a requestor. The number of processor units receives a result set from searching the set of databases using the set of access paths selected for the set of databases. The number of processor units removes a number of duplicate records from records in the result set. The number of processor units sends the result set with the number of duplicate records removed to the requestor. According to other illustrative embodiments, a computer system and a computer program product for processing a search query are provided.

### BRIEF DESCRIPTION OF THE DRAWINGS

FIG. 1 is a diagram illustrating a cloud computing environment in which illustrative embodiments can be implemented;

FIG. 2 is a diagram illustrating abstraction model layers in accordance with an illustrative embodiment;

FIG. 3 is a pictorial representation of a network of data processing systems in which illustrative embodiments can be implemented;

FIG. 4 is a block diagram of a database environment in accordance with an illustrative embodiment;

FIG. 5 is an illustration of dataflow for processing a search query to generate a result set in accordance with an illustrative embodiment;

FIG. 6 is an illustration of access paths for searching a database in accordance with an illustrative embodiment;

FIG. 7 is an illustration of merging records in a result set in accordance with an illustrative embodiment;

FIG. 8 is an illustration of a result set containing an expression in accordance with an illustrative embodiment;

FIG. 9 is a flowchart of a process for processing a search query in accordance with an illustrative embodiment;

FIG. 10 is a flowchart of a process for marking a result set in accordance with an illustrative embodiment;

FIG. 11 is a flowchart of a process marking records in accordance with an illustrative embodiment;

FIG. 12 is a flowchart of a process processing a search result marking records in accordance with an illustrative embodiment;

FIG. 13 is a flowchart of a process returning a result set in accordance with an illustrative embodiment;

FIG. 14 is a flowchart of a process processing a search result in accordance with an illustrative embodiment;

FIG. 15 is a flowchart of a process for selecting access path in accordance with an illustrative embodiment; and

FIG. 16 is a block diagram of a data processing system in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

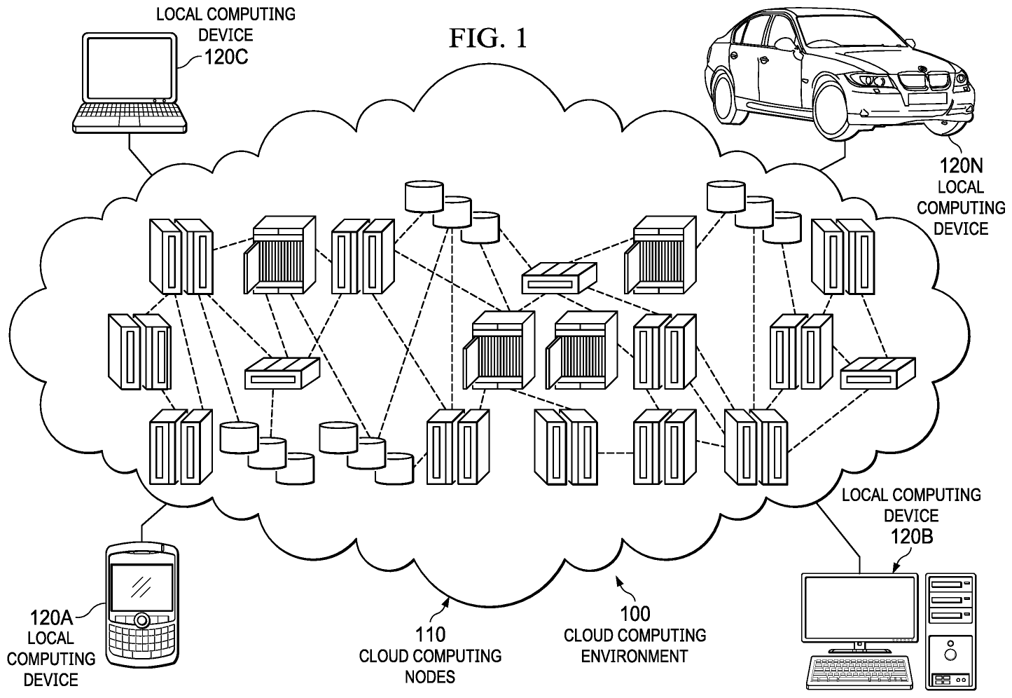

With reference now to FIG. 1, a diagram illustrating a cloud computing environment is depicted in which illustrative embodiments may be implemented. In this illustrative example, cloud computing environment 100 includes a set of one or more cloud computing nodes 110 with which local computing devices used by cloud consumers, such as, for example, personal digital assistant or smart phone 120A, desktop computer 120B, laptop computer 120C, and/or automobile computer system 120N, may communicate.

Cloud computing nodes 110 may communicate with one another and may be grouped physically or virtually into one or more networks, such as private, community, public, or hybrid clouds as described hereinabove, or a combination thereof. This allows cloud computing environment 100 to offer infrastructure, platforms, and/or software as services for which a cloud consumer does not need to maintain resources on a local computing device, such as local computing devices 120A-120N. It is understood that the types of local computing devices 120A-120N are intended to be illustrative only and that cloud computing nodes 110 and cloud computing environment 100 can communicate with any type of computerized device over any type of network and/or network addressable connection using a web browser, for example.

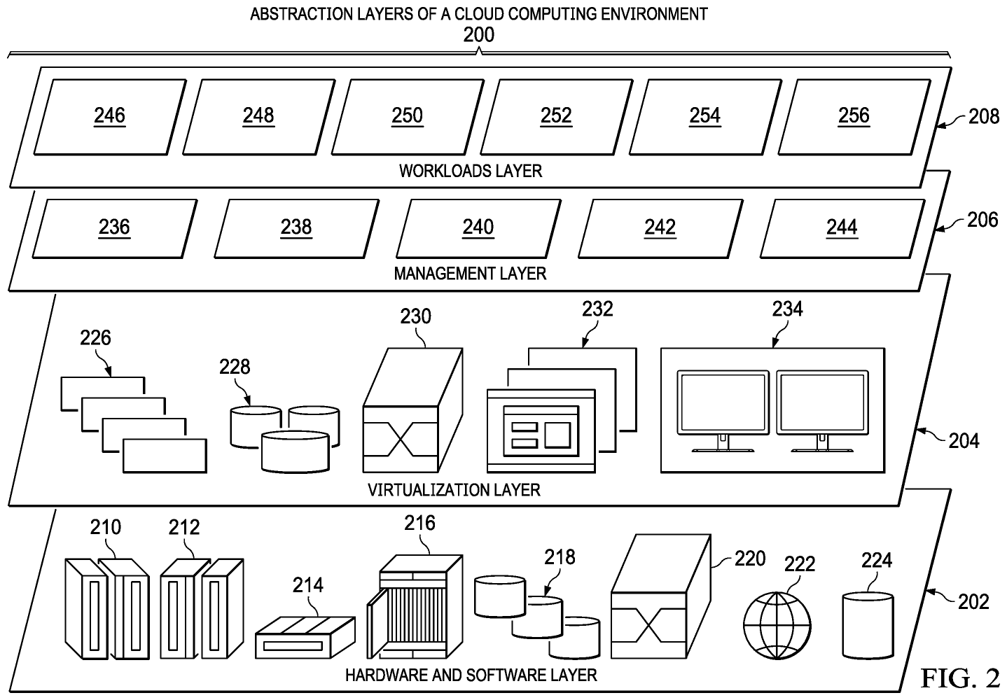

With reference now to FIG. 2, a diagram illustrating abstraction model layers is depicted in accordance with an illustrative embodiment. The set of functional abstraction layers shown in this illustrative example may be provided by a cloud computing environment, such as cloud computing environment 100 in FIG. 1. It should be understood in advance that the components, layers, and functions shown in FIG. 2 are intended to be illustrative only and embodiments of the invention are not limited thereto. As depicted, the following layers and corresponding functions are provided.

Abstraction layers of a cloud computing environment 200 include hardware and software layer 202, virtualization layer 204, management layer 206, and workloads layer 208. Hardware and software layer 202 includes the hardware and software components of the cloud computing environment. The hardware components may include, for example, mainframes 210, RISC (Reduced Instruction Set Computer) architecture-based servers 212, servers 214, blade servers 216, storage devices 218, and networks and networking components 220. In some illustrative embodiments, software components may include, for example, network application server software 222 and database software 224.

Virtualization layer 204 provides an abstraction layer from which the following examples of virtual entities may be provided: virtual servers 226; virtual storage 228; virtual networks 230, including virtual private networks; virtual applications and operating systems 232; and virtual clients 234.

In one example, management layer 206 may provide the functions described below. Resource provisioning 236 provides dynamic procurement of computing resources and other resources, which are utilized to perform tasks within the cloud computing environment. Metering and pricing 238 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 240 provides access to the cloud computing environment for consumers and system administrators. Service level management 242 provides cloud computing resource allocation and management such that required service levels are met. Service level agreement (SLA) planning and fulfillment 244 provides pre-arrangement for, and procurement of, cloud computing resources for which a future requirement is anticipated in accordance with an SLA.

Workloads layer 208 provides examples of functionality for which the cloud computing environment may be utilized. Example workloads and functions, which may be provided by workload layer 208, may include mapping and navigation 246, software development and lifecycle management 248, virtual classroom education delivery 250, data analytics processing 252, transaction processing 254, and database search 256.

In this illustrative example, database search 256 can be used to search databases and manage the searching in a manner that reduces duplicated records in the search result returned to a client sending a search query. In this illustrative example, database search 256 can take into account network costs in addition to central processor unit (CPU) and input/output (I/O) costs for performing searches. The illustrative examples recognize and take into account that current techniques do not take into account a network cost in performing searches.

The illustrative examples recognize and take into account that duplicated records can be present in the results returned from a search performed by database search 256 in response to a search query from the requestor. The illustrative embodiments recognize and take into account that as the number of duplicated records increases, the amount of network resources needed to return the search result to the requestor over a network.

The illustrative embodiments recognize and take into account that it would be desirable to reduce the network cost for obtaining search results. One or more sets of search results can be referred to as a result set. The illustrative embodiments recognize and take into account that the network cost can be taken into account into a cost calculation for processing search queries in databases. The newest embodiments recognize and take into account that this cost for processing search queries can also include the cost for returning search results over a network to a requester. The illustrative embodiments recognize and take into account that reducing the network cost can increase the responsiveness perceived by the requestor.

Thus, the illustrative embodiments provide a computer implemented method, apparatus, system, and computer program products for processing a search query. A number of processor units selects an access path from access paths for each database in a set of databases based on reducing a cost for searching the set of databases using a set of access paths selected for the set of databases in response to receiving the search query from a requestor. The number of processor units receives a result set from searching the set of databases using a set of access paths selected for the set of databases. The number of processor units removes a number of duplicate records from records in the result set. The number of processor units sends the result set with the number of duplicate records removed to the requestor.

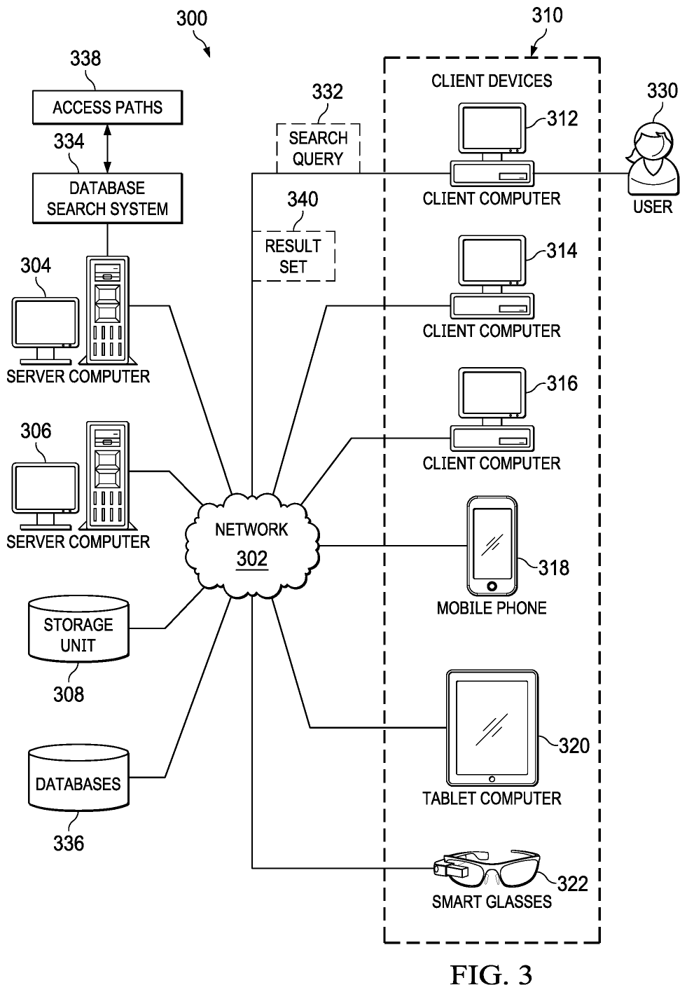

With reference now to FIG. 3, a pictorial representation of a network of data processing systems is depicted in which illustrative embodiments may be implemented. Network data processing system 300 is a network of computers in which the illustrative embodiments may be implemented. Network data processing system 300 contains network 302, which is the medium used to provide communications links between various devices and computers connected together within network data processing system 300. Network 302 may include connections, such as wire, wireless communication links, or fiber optic cables.

In the depicted example, server computer 304 and server computer 306 connect to network 302 along with storage unit 308. In addition, client devices 310 connect to network 302. As depicted, client devices 310 include client computer 312, client computer 314, and client computer 316. Client devices 310 can be, for example, computers, workstations, or network computers. In the depicted example, server computer 304 provides information, such as boot files, operating system images, and applications to client devices 310. Further, client devices 310 can also include other types of client devices such as mobile phone 318, tablet computer 320, and smart glasses 322. In this illustrative example, server computer 304, server computer 306, storage unit 308, and client devices 310 are network devices that connect to network 302 in which network 302 is the communications media for these network devices. Some or all of client devices 310 may form an Internet-of-things (IoT) in which these physical devices can connect to network 302 and exchange information with each other over network 302.

Client devices 310 are clients to server computer 304 in this example. Network data processing system 300 may include additional server computers, client computers, and other devices not shown. Client devices 310 connect to network 302 utilizing at least one of wired, optical fiber, or wireless connections.

Program code located in network data processing system 300 can be stored on a computer-recordable storage media and downloaded to a data processing system or other device for use. For example, program code can be stored on a computer-recordable storage media on server computer 304 and downloaded to client devices 310 over network 302 for use on client devices 310.

In the depicted example, network data processing system 300 is the Internet with network 302 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 300 also may be implemented using a number of different types of networks. For example, network 302 can be comprised of at least one of the Internet, an intranet, a local area network (LAN), a metropolitan area network (MAN), or a wide area network (WAN). FIG. 3 is intended as an example, and not as an architectural limitation for the different illustrative embodiments.

As used herein, “a number of” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C; or item B and item C. Of course, any combinations of these items can be present. In some illustrative examples, “at least one of” can be, for example, without limitation, two of item A; one of item B; and ten of item C; four of item B and seven of item C; or other suitable combinations.

In this illustrative example, user 330 can use client computer 312 to send search query 332 to database search system 334 located in server computer 304. Database search system 334 can search a set of databases 336. As used herein, a set of, when used with reference to items, means one or more items. For example, a set of databases 336 is one or more of databases 336. The search can return result set 340. Result set 340 can include one or more records from one or more databases in the set of databases 336.

In this illustrative example, database search system 334 can search the set of databases 336 taking into account costs for searching the set of databases 336. The costs taken into account by database search system 334 can include costs such as input/output (I/O) costs and central processor unit (CPU) costs. Additionally, database search system 334 can also take into account into network costs. The network cost can include the cost for database search system 334 to access the set of databases 336 over network 302.

Database search system 334 can analyze the cost to use access paths 338 for searching the set of databases 336. In this illustrative example, a database in the set of databases 336 can be searched using multiple access paths in access paths 338. Database search system 334 can perform an analysis of the access path can be made to determine which access path has a lowest-cost for searching a database.

The network cost can include the cost for database search system 334 to send result set 340 to user 330. Database search system 334 can remove duplicate records from result set 340 returned from searching databases 336. Additionally, database search system 334 can mark result set 340 to indicate which records in result set 340 has duplicate records. Further, database search system 334 can include an indication of how many duplicate records are present for result set 340. Thus, the size of result set 340 can be reduced, reducing the network cost to send result set 340 to user 330 over network 302.

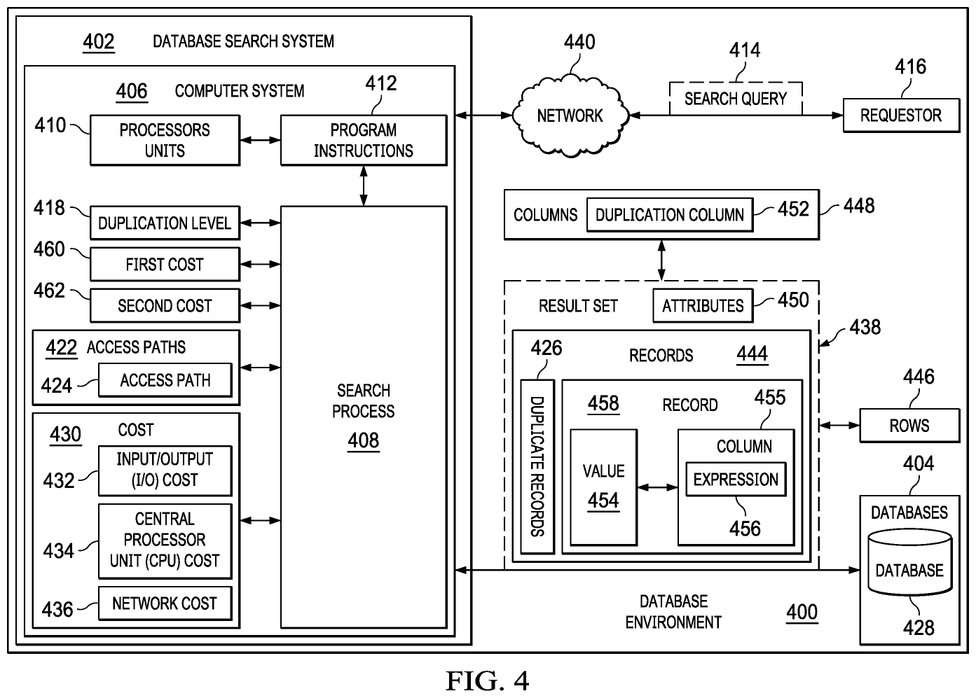

With reference now to FIG. 4, a block diagram of a database environment is depicted in accordance with an illustrative embodiment. In this illustrative example, database environment 400 includes components that can be implemented in hardware such as the hardware shown in network data processing system 300 in FIG. 3.

In this illustrative example, database search system 402 can search a set of databases 404 in a manner that can reduce the network cost for the search. In this illustrative example, database search system 402 comprises computer system 406 and search process 408.

Search process 408 can be implemented in software, hardware, firmware, or a combination thereof. When software is used, the operations performed by search process 408 can be implemented in program instructions configured to run on hardware, such as a processor unit. When firmware is used, the operations performed by search process 408 can be implemented in program instructions and data and stored in persistent memory to run on a processor unit. When hardware is employed, the hardware can include circuits that operate to perform the operations in search process 408.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 406 is a physical hardware system and includes one or more data processing systems. When more than one data processing system is present in computer system 406, those data processing systems are in communication with each other using a communications medium. The communications medium can be a network. The data processing systems can be selected from at least one of a computer, a server computer, a tablet computer, or some other suitable data processing system.

As depicted, computer system 406 includes a number of processor units 410 that are capable of executing program instructions 412 implementing processes in the illustrative examples. As used herein, a processor unit in the number of processor units 410 is a hardware device and is comprised of hardware circuits such as those on an integrated circuit that respond and process instructions and program code that operate a computer. When a number of processor units 410 execute program instructions 412 for a process, the number of processor units 410 is one or more processor units that can be on the same computer or on different computers. In other words, the process can be distributed between processor units on the same or different computers in a computer system. Further, the number of processor units 410 can be of the same type or different type of processor units. For example, a number of processor units can be selected from at least one of a single core processor, a dual-core processor, a multi-processor core, a general-purpose central processor unit (CPU), a graphics processing unit (GPU), a digital signal processor (DSP), or some other type of processor unit.

In this example, search process 408 can receive search query 414 from requestor 416. In the illustrative example, requestor 416 can take a number of different forms. For example, requestor 416 can be one of a person, a program, or a software process.

As depicted, search process 408 can determine duplication level 418 for access paths 422 for searching a set of databases 404 using the search query 414 received from requestor 416. An access path describes how items such as records are retrieved in response to a search of a database. An access path describes at least one of database objects or operations used to perform the search. These database objects can be any defined object in a database that is used to store reference data. A database object can be selected from a least one of a table, a view, a record, a cluster, an index, or other objects. Operations can be, for example, scan, fetch, join, or other types of operations used to search a database.

In this illustrative example, search process 408 selects access path 424 from access paths 422 for each database in the set of databases 404 based on reducing cost 430 for searching the set of databases 404. Cost 430 can be measured using at least one of time, amount of work, amount of resources, or some other type of measurement.

The selection of access path 424 from access paths 422 to search database 428 in the set of databases 404 can have an impact on the performance of computer system 406. Further, the performance of computer system 406 can also include a network cost in the form of the time to send a response to requestor 416 over network 440. This time, as well as the time needed to perform the search, can be perceived by requestor 416 as the responsiveness of computer system 406. In other examples, the network cost can take other forms such as resource use or other metrics associated with using network 440.

In this illustrative example, the performance for one access path compared to another access path for searching database 428 can be measured based on cost 430. For example, access path 424 has a cost involved in performing the search using search query 414. This cost can be determined by considering at least one of input/output (I/O) cost 432, central processor unit (CPU) cost 434, or network cost 436.

Input/output cost 432 can be the cost to perform input/output operations when processing search query 414. In this example, central processor unit cost 434 is the use of the central processor unit when processing search query 414. Network cost 436 is the use of network resources to process search query 414. For example, in processing search query 414, some operations may involve accessing or sending requests over a network connection to obtain search results from a database. Thus, network cost 436 can also considered as compared currently use techniques for determining the cost of access paths 422.

In one illustrative example, cost 430 can be calculated as follows:

Cost=General Cost+(Page Cost+Row Cost+Scan Cost)*Reduction ratio+mark Cost+Network Cost.

The general cost includes in general operations such as parse the query, build parse tree, get database object statistics, and other operations. Page cost is the cost to access a page, row cost is the cost to access a row in a table, and scan cost is a cost to scan or check a database object. The database object can be, for example, a table. Reduction ratio is Hit rate*(1−CollNum/TotalNum). Hit rate is percent of rows of columns returned for the query; CollNum is the number of columns searched in a table; and TotalNum is the total number of rows in the table. In this example, mark Cost is the cost to mark duplicate records. This cost can include the cost to add a column to the results and to include values indicating the number of duplicate records. Network cost is the cost to send the search result over a network to the requester. Network cost can also include any access made over a network to process the search query. These costs can be placed into categories such as central processor unit cost 434, input/output cost 432, and network cost 436.

In one illustrative example, search process 408 can select access path 424 from access paths 422 to search database 428 in a manner that reduces cost 430 to process search query 414 in the set of databases 404. Search process 408 can select access path 424 in access paths 422 for each database in the set of databases 404 having a lowest cost.

With the selection of access path 424 for each database in the set of databases 404 to process search query 414, search process 408 can use the selected access paths to search the set of databases 404 and receive result set 438. Search process 408 can remove a number of duplicate records 426 from result set 438 and send result set 438 with the number of duplicate records 426 removed to requestor 416. In this example, result set 438 can have a style comprising one of an in order result set, almost in order result set, and a disorder result set.

Sending result set 438 to requestor 416 over network 440 can result in improved performance based on selecting access path 424 based on cost 430. With a reduction in the number of duplicate records 426 in result set 438, the amount of network resources needed to send result set 438 over network 440 is reduced. This reduction can be significant if, for example, one million records in result set 438 can be reduced to 400,000 records through removing the number of duplicate records 426.

In this illustrative example, search process 408 can also mark result set 438 to indicate duplications for records 444 in result set 438 to send to requestor 416. In other words, result set 438 can include information that indicates the number of duplicate records 426 for records 444 that were removed from result set 438 prior to sending result set 438 to requestor 416 over network 440.

In one illustrative example, result set 438 can comprise rows 446 for records 444 and columns 448 for attributes 450 for records 444. Search process 408 can add duplication column 452 to result set 438. Search process 408 can indicate the number of duplicate records 426 removed for records 444 in duplication column 452. The number of duplicate records 426 removed can be indicated in a number of different ways. For example, a number of duplicate records 426 can be used. In another example, the number of duplicate records 426 can be indicated using categories. For example, categories can be low, medium, and high. In another illustrative example, the categories can be ranges of duplicate records such as 1-1000, 1001-10,000, 10,0001-100,000, and 100,001-1,000,000.

Thus, removing duplicate records 426 from records 444 in result set 438 can reduce cost 430 for sending result set 438 over network 440. In this manner, a further reduction in network cost can occur in addition to taking this cost into account when selecting an access path for searching database. This reduction in network cost 436 can be perceived by requestor 416 as an improvement in response time. In this manner, search process 408 can process search query 414 in a manner that can meet service level agreements (SLAs) more easily as compared to current processes for processing search queries.

In this illustrative example, in addition to removing the number of duplicate records 426 in records 444 in result set 438 returned from searching set of databases 404, search process 408 can merge the result set 438 with the duplications marked for records 444. For example, result set 438 received from the set of databases 404 can be in the form of multiple tables in which one or more tables can be received from each database in the set of databases 404. These tables can be merged into a single table or data structure in result set 438.

Additionally, in some cases, cost 430 to process search query 414 can be lower without removing duplicate records 426. For example, search process 408 can calculate first cost 460 for result set 438 in which duplicate records 426 are removed and marking is performed. In this example, first cost 460 takes into account input/output cost 432, central processor unit cost 434, and network cost 436. Search process 408 can also calculate second cost 462 of result set 438 in which duplicate records are not removed and marking is not performed. Second cost 462 takes into account input/output cost 432, central processor unit cost 434, and network cost 436.

In this illustrative example, search process 408 returns result set 438 in which duplicate records 426 are not removed and marking is not performed to requestor 416 instead of result set 438 in which the number of duplicate records 426 are removed and marking is performed if second cost 462 less than or equal to the first cost 460. This cost analysis takes into account a situation in which cost 430 for removing the number of duplicate records 426 is the same or greater than not removing duplicate records 426 from result set 438.

In yet another example, the size of result set 438 can be further reduced by replacing value 454 in record 458 in result set 438 with expression 456 indicating a relationship of value 454 in column 455 with a set of other values in record 458. In other words, expression 456 can describe how to obtain value 454 from the set of other values in record 458. Associating expression 456 with that column in place of including the values can reduce the size of result set 438. For example, if 1,000,000 records are present in result set 438, removing 10 million values for column 455 and associating expression 456 with column 455 can result set 438 can reduce the network cost 436. In other words, expression 456 can be assigned to or associated with column 455 and 1,000,000 values can be removed.

Thus, expression 456 can reduce a size of result set 438 sent to requestor 416. These reductions can reduce network cost 436 and improve performance in processing search query 414.

In one illustrative example, one or more technical solutions are present that overcome a technical problem with reducing the cost for processing a search query in which the cost includes a network cost. As a result, one or more technical solutions can provide a technical effect reducing the cost through various features including at least one of selecting an access path with the lowest cost, removing duplicate records, or replacing values in a column with a single expression.

Computer system 406 can be configured to perform at least one of the steps, operations, or actions described in the different illustrative examples using software, hardware, firmware, or a combination thereof. As a result, computer system 406 operates as a special purpose computer system in which search process 408 in computer system 406 enables processing a search query and returning a search set with a lower cost by taking into account network costs for processing the search query. In particular, search process 408 transforms computer system 406 into a special purpose computer system as compared to currently available general computer systems that do not have search process 408.

In this manner, search process 408 in computer system 406 provides a practical application of processing a search query such that the function of computer system 406 is improved. For example, a reduced use of network resources can occur when computer system 406 operates using search process 408. The reduced use of network resources can occur through a selection of access paths, removing duplicate records, and using expressions.

The illustration of database environment 400 in FIG. 4 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, the set of databases are shown as being directly connected to computer system 406. In some examples, the set of databases 404 can be accessed via a network such as network 440, which may be the Internet or a cloud environment. In yet another illustrative example, one or more sets of databases in addition to the set of databases 404 can be present by search process 408 processing search query 414. In this example, the different sets of databases 404 can be clusters in which each cluster is managed using an instance of a search server.

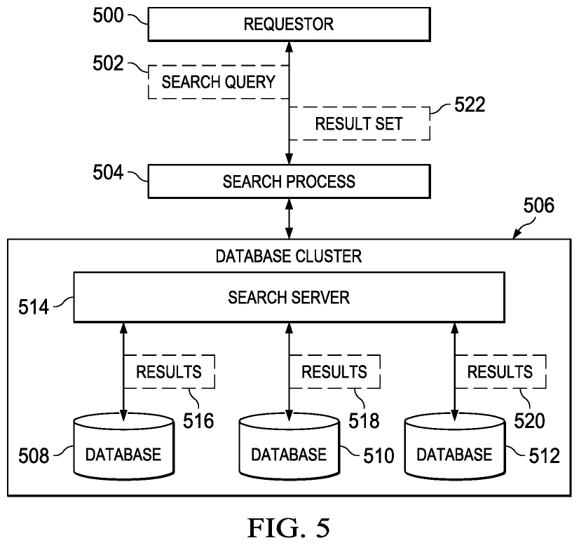

With reference next to FIG. 5, an illustration of dataflow for processing a search query to generate a result set is depicted in accordance with an illustrative embodiment. In this illustrative example, the dataflow begins with requestor 500 sending search query 502 to search process 504. In this illustrative example, requestor 500 is a database client, which can be a person or program. Search process 504 is an example of search process 408 in FIG. 4.

In this illustrative of example, search process 504 can search database cluster 506 using search query 502. Database cluster 506 has a set of databases: database 508, database 510, and database 512. Search process 504 can select access paths for searching database 508, database 510, and database 512. Access paths can be selected in a manner that reduces the cost for searching the databases. In the illustrative example, the cost for the access paths can be calculated in a manner that also takes into account any network costs for performing the search. Network costs can be present when different steps or operations require access to or over a network. Search process 504 can use search server 514 in database cluster 506 to search these databases using the selected access paths.

As depicted, database 508 returns results 516, database 510 returns results 518, and database 512 returns results 520, which can be records in a tables returned from searching a database using the access path selected for the database. Search process 504 receives these results to form result set 522. These tables in the results can be merged to form a single table for result set 522. Search process 504 returns result set 522 to requestor 500.

In this illustrative example, the reduction of duplicate records in result set 522 can be performed in a number of different ways. For example, access paths can be selected for searching the databases in database cluster 506 in manner that reduces the number of duplicate records. As another example, the results returned by search server 514 to search process 504 from searching the databases can be processed to remove duplicate records that are returned. In this example, search process 504 performs marking of result set 522 in which duplicate records are removed and information about the duplicate records is marked in an additional column to result set 522.

Further, search process 504 can also use an expression in a selected column in place of all of the values in that selected column. This replacement can be performed when a value in the column is derived from values in another column or columns. The expression can be used to represent the calculations needed to obtain the value for the selected column or columns from which the value is derived. The replacement of the value in the selected column with the expression can result in in a reduced size for result set 522.

Thus, the different illustrative examples can be used to reduce the size of result set 522 sent to requestor 500. These reductions in the size of result set 522 can reduce the network cost for sending result set 522 to requestor 500.

Further, search process 504 can also determine whether the cost for sending result set 522 is the same or less without marking result set 522 to requestor 500. This cost can take into the cost for performing the marking and the cost to send the marked result set as compared to not performing marking of results at 522.

Illustration of the dataflow in FIG. 5 is provided as an example and not meant to limit the manner in which other illustrative examples can be implemented. For example, other numbers of databases may be present other than the three databases shown in database cluster 506. In still other illustrative examples, multiple clusters or individual databases can be present in which search process 504 searches to process search query 502.

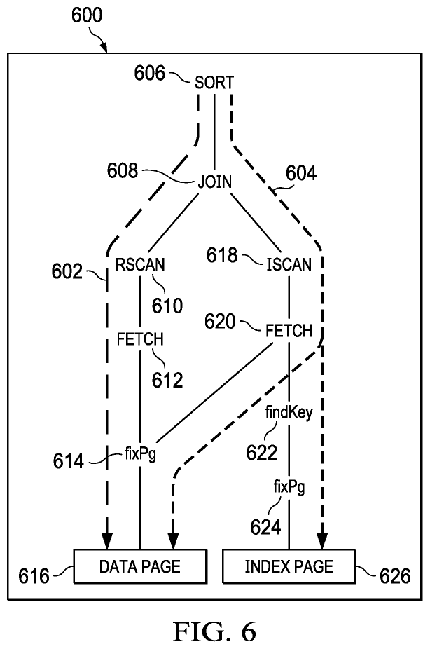

Turning now to FIG. 6, an illustration of access paths for searching a database is depicted in accordance with an illustrative embodiment. In this example, access paths 600 are examples of access paths 422 shown in block form in FIG. 4. As the depicted, access paths 600 include access path 602 and access path 604.

As depicted, access path 602 uses Sort 606, Join, 608, rscan 610, fetch 612, and fixPg 614 as operations to access information in data page 616. Access path 604 also accesses data page 616. With this access path, Sort 606, Join, 608, iscan 618, fetch 620, findKey 622, and fixPg 624 are operations used to identify index page 626, which can then be used to access data page 616 using the operation fixPg 614.

In this example, access path 602 has a lower cost as compared access path 604. This access path is selected for use in searching for records responsive to a search. Illustration of access paths 600 is provided as an alteration of one manner in which access paths 422 and FIG. 4 can be implemented. In other illustrative examples, other numbers of access paths can be present for accessing a database. For example, three access paths, seven access paths, or some other number of access paths can be present for consideration in access paths 600 to select an access path for performing a search.

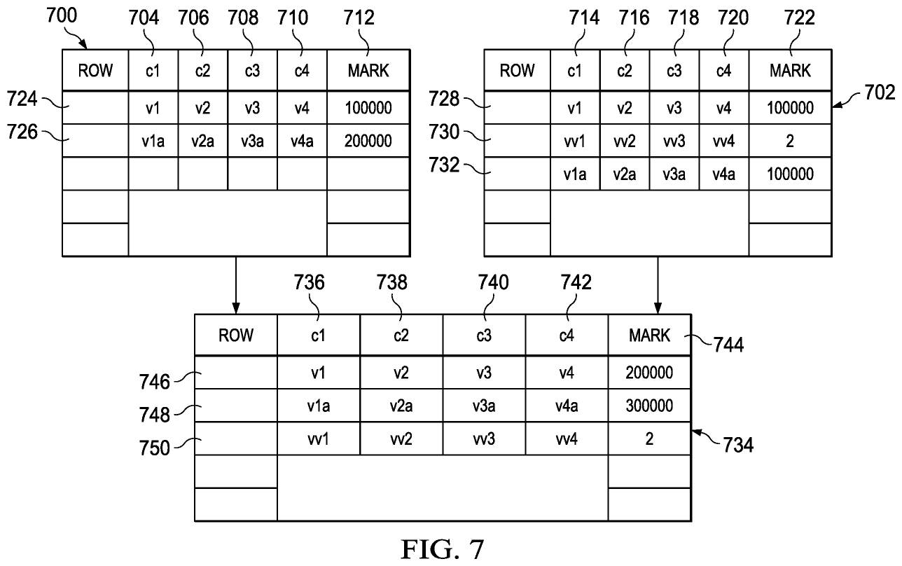

Next in FIG. 7, an illustration of merging records in a result set is depicted in accordance with an illustrative embodiment. As depicted, table 700 and table 702 are returned as results from searching two different databases. As depicted, the rows in the tables represent records and contain values for the variables identified in the columns.

As depicted, table 700 has columns: C1 704, C2 706, C3 708, C4 710, and mark 712. Table 702 has columns: C1 714, C2 716, C3 718, C4 720, and mark 722. In this example, C1 704, C2 706, C3 708, C4 710, C1 714, C2 716, C3 718, and C4 720 are columns that represent features or variables. In this example, these columns are keys from the search query in the search results returned and these columns with these keys have the key values from the search query.

Removal of duplicate records and marking has occurred in table 700 and table 702. Mark 712 and mark 722 are columns that can be used to indicate duplicate records that have been removed for records in the tables. In this example, this indication in each record can be a value identifying the number of duplicate records for a particular record.

For example, in table 700, mark 712 for the record in row 724 indicates that the record has 100,000 duplicate records that were removed. Mark 712 for row 726 indicates that the record has 200,000 duplicate records that were removed.

As another example, in table 702, mark 722 for row 728 indicates that the record has 100,000 duplicate records that were removed. Mark 722 for row 730 indicates that the record has 2 duplicate records that were removed, and Mark 722 for row 732 indicates that the record has 100,000 duplicate records that were removed.

In this illustration example, table 700 and table 702 form a result set that can be merged to form table 734. As depicted, table 734 has columns C1 736, C2 738, C3 740, C4 742, and mark 744. Table 734 has row 746, row 748, and row 750. Row 746 is created from merging row 724 in table 700 and row 728 in table 702. Row 748 is created from merging row 726 in table 700 with row 732 in table 702. Row 750 is created from row 730 in table 702.

As depicted, mark 744 is a column that indicates the duplicate records removed for each of the rows from the merger of table 700 and table 702. For example, mark 744 for row 746 indicates that 200,000 duplicate records were removed and indicates for row 748 that 300,000 duplicate records were removed. Mark 744 indicates that 2 duplicate records were removed for row 750.

The illustration of table 700 and table 702 joined to form table 734 is one example of how tables can be merged in a result set. In other illustrative examples, other numbers of tables can be present and merged. For example, 5 tables, 11 tables, or some other number of tables can be present that are merged to form a single table for the result set.

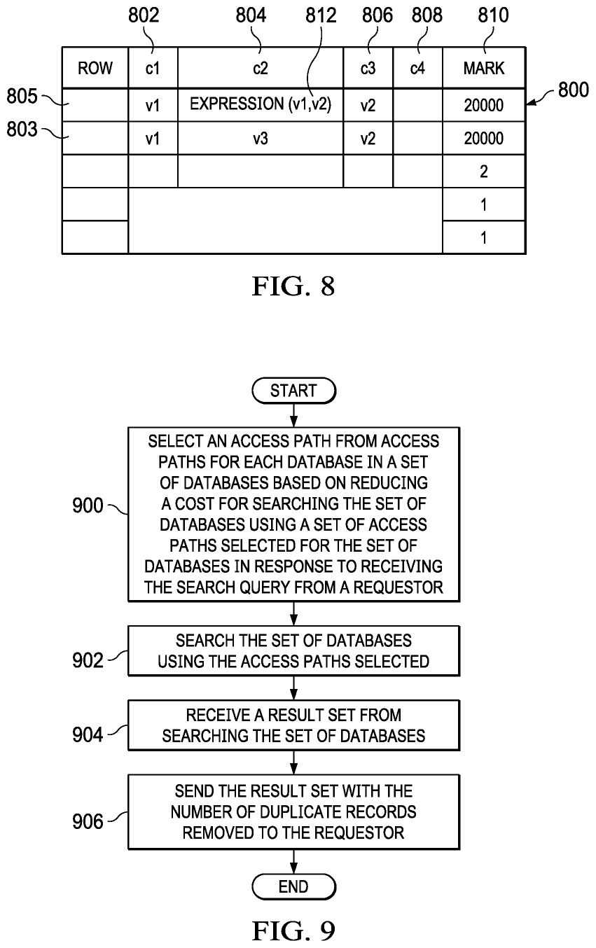

With reference now to FIG. 8, an illustration of a result set containing an expression is depicted in accordance with an illustrative embodiment. Table 800 comprises rows for records. As depicted, table 800 has columns C1 802, C2 804, C3 806, C4 808, and Mark 810. Columns C1 802, C2 804, C3 806, and C4 808 represent variables for the records. Each row represents a record and contains values for variables identified in the columns.

In this illustrative example, a reduction in the size of table 800 can occur through using an expression in place of values in a column. This type of replacement of values can occur when the values in a column are based off on values in one or more columns in table 800. For example, in row 803, the value V3 in C2 804 is determined based on the value V1 in C1 802 and the value V2 in C3 806.

For example, C1 802 can be an ID card number, C3 806 can be the name of a user, and C2 804 can be a login name for the user. In this example, the login name for the user is based on a formula of name of the user+last 6 digits of the ID card number.

Instead of using value V3 as depicted in row 803, expression (V1, V2) 812 can be used as depicted in row 805. In the illustrative example, expression (V1, V2) 812 can be defined for C2 804 such that values such as V3 in the row do not have to be sent for each record in table 800. When a value is desired for C2 804 in a selected row, that value can be determined using expression (V1, V2) 812 for that selected row.

As a result, the amount of data sent in table 800 can be reduced, reducing the size of table 800. In this manner, the use of expressions in addition to removing duplicate records can reduce the cost to send a result set over a network to a requestor.

This illustration of expression (V1, V2) 812 in table 800 is meant as an example and not to limit the manner in which other examples can be implemented. For example, another table may include additional columns in which one or more expressions can be used in place of values in those columns. In yet another illustrative example, an expression can be based on three columns rather than two columns as depicted for expression 812.

Turning next to FIG. 9, a flowchart of a process for processing a search query is depicted in accordance with an illustrative embodiment. The process in FIG. 9 can be implemented in hardware, software, or both. When implemented in software, the process can take the form of program instructions that is run by one of more processor units located in one or more hardware devices in one or more computer systems. For example, the process can be implemented in search process 408 in computer system 406 in FIG. 4.

The process beings selecting an access path from access paths for each database in a set of databases based on reducing a cost for searching the set of databases using a set of access paths selected for the set of databases in response to receiving the search query from a requestor (step (900).

The process searches the set of databases using the access paths selected (step 902). The process receives a result set from searching the set of databases (step 904).

The process sends the result set with the number duplicate records removed to the requestor (step 906). The process terminates thereafter. In step 906, the process can send the result set with the reduced number of duplicate records over a network to the requestor. In this example, a network cost is reduced for sending result set with the reduced number of duplicate records over the network as compared to sending the result set without the reduced number of duplicate records.

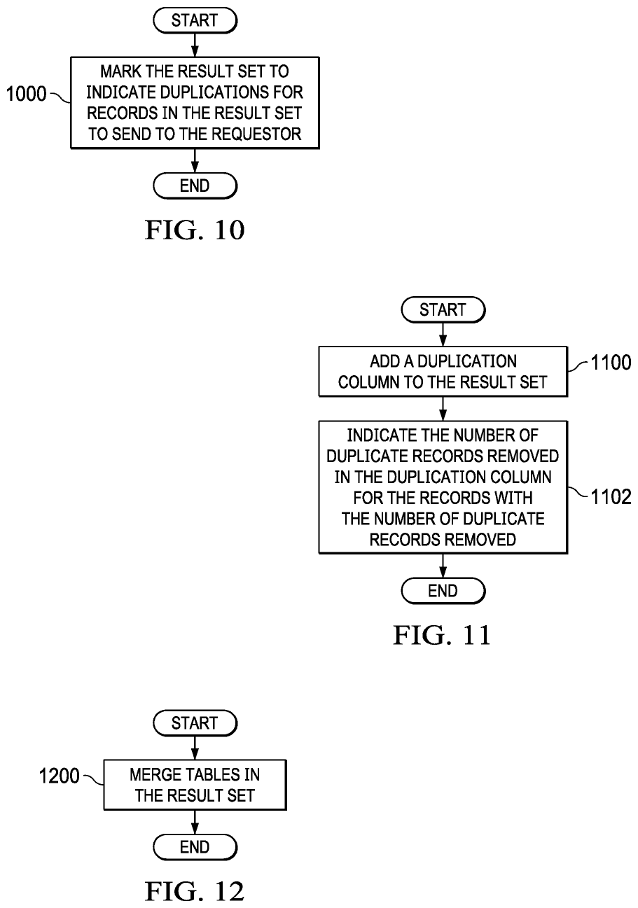

With reference to FIG. 10, a flowchart of a process for marking a result set is depicted in accordance with an illustrative embodiment. The process in FIG. 10 is an example of an additional step that can be performed with the process in FIG. 9. These steps can be performed to mark the fact that duplicate records were removed from the records in the result set sent to the requestor in step 906 in FIG. 9.

The process marks the result set to indicate duplications for records in the result set to send to the requestor (step 1000). The process terminates thereafter.

Turning now to FIG. 11, a flowchart of a process for marking records is depicted in accordance with an illustrative embodiment. The process in FIG. 11 is an example of an implementation for step 1000 in FIG. 10. In this example, the result set can be in any data structure such as a table. The result set can comprise rows for the records and columns for attributes.

The process adds a duplication column to the result set (step 1100). The process indicates the duplication level in the duplication column for records the number of duplicate records removed (step 1102). The process terminates thereafter. The duplication column is used to identify how many duplicate records are present for the record.

With reference to FIG. 12, a flowchart of a process processing a search result marking records is depicted in accordance with an illustrative embodiment. The process in FIG. 12 is an example of a step that can be performed in addition to the steps in FIG. 9.

The process merges tables in the result set (step 1200). The process terminates thereafter.

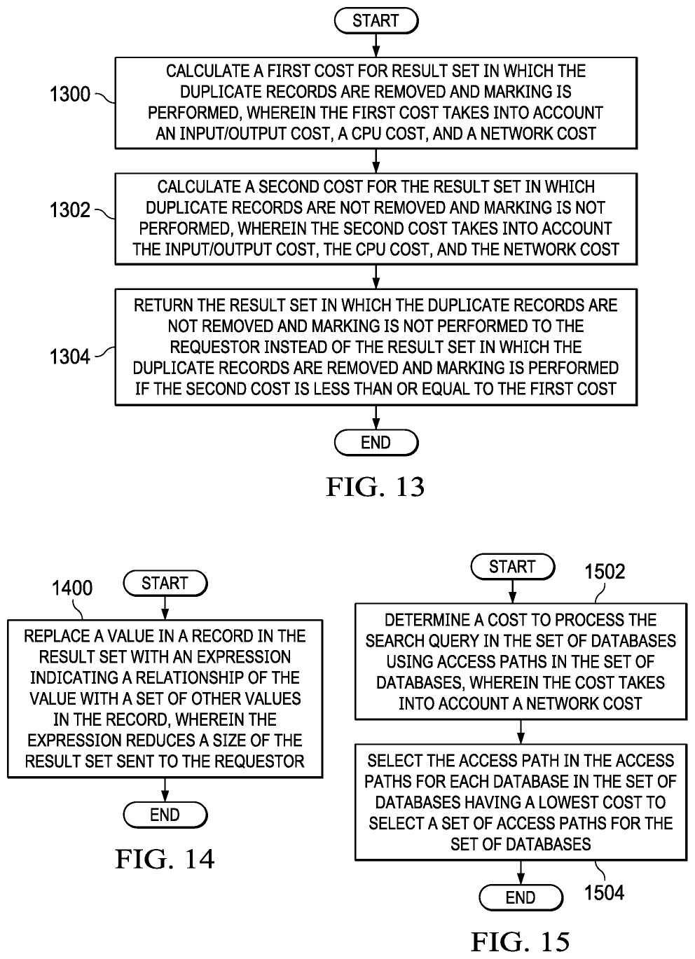

Turning now to FIG. 13, a flowchart of a process returning a result set is depicted in accordance with an illustrative embodiment. The process in FIG. 13 is an example of additional steps that can be performed with the process in FIG. 9.

The process begins by calculating a first cost for result set in which the duplicate records are removed and marking is performed, wherein the first cost takes into account an input/output cost, a CPU cost, and a network cost (step 1300). The process calculates a second cost for result set in which duplicate records are not removed and marking is not performed, wherein the second cost takes into account the input/output cost, the CPU cost, and the network cost (step 1302).

The process returns the result set in which the duplicate records are not removed and marking is not performed to the requestor instead of the result set in which the duplicate records are removed and marking is performed if the second cost less than or equal to the first cost (step 1304). The process terminates thereafter.

In some cases, removing duplicate records and performing marking for the result set that can increase the cost for returning the result set. In this example, the other costs in addition to network cost or taken into account when determining the overall cost for marking or not marking the result set. Based on the cost, removal duplicate records and the marking can be omitted in the result set sent to the requestor. In other words, the cost for processing the results sets show the occasion level may incur the same or more cost in terms I/O cost, CPU cost, or both than the savings for the network cost. As a result, the overall cost can be less for the same to send the result set without removing duplicate records and marking. In yet another was example, the removal duplicate records can occur without marking.

In FIG. 14, a flowchart of a process processing a search result is depicted in accordance with an illustrative embodiment. The process in FIG. 13 is an example of an additional step that can be performed with the process in FIG. 9.

The process replaces a value in a record in the result set with an expression indicating a relationship of the value with a set of other values in the record, wherein the expression reduces a size of the result set sent to the requestor (step 1400). The process terminates thereafter. In this depicted example, the use of an expression in place of a value can reduce the amount of data that is transmitted over a network. This reduction can further reduce the network cost for sending the result set.

Turning to FIG. 15, a flowchart of a process for selecting access path is depicted in accordance with an illustrative embodiment. The process illustrated in FIG. 15 is an example of one implementation for step 900 in FIG. 9.

The process determines a cost to process the search query in the set of databases using the access paths in the set of databases, wherein the cost takes into account a network cost (step 1500). The process selects the access path in the set of access paths for each database in the set of databases having a lowest cost to select a set of access paths for the set of databases (step 1502). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

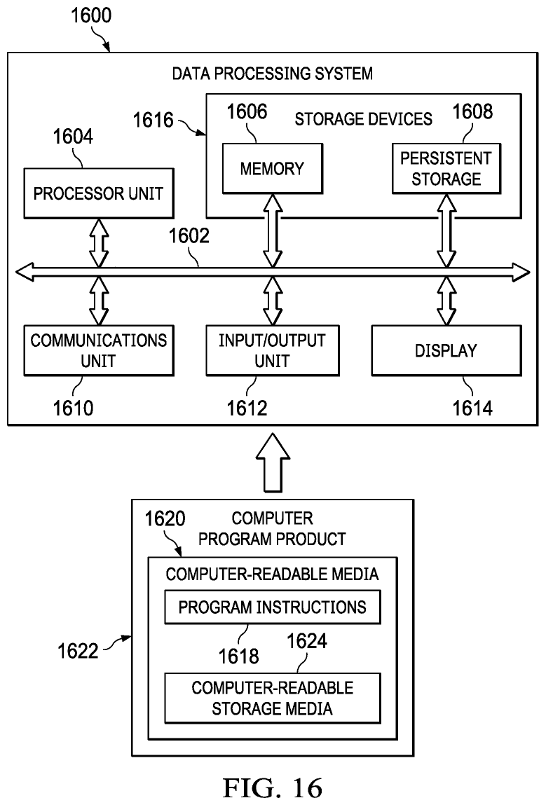

Turning now to FIG. 16, a block diagram of a data processing system is depicted in accordance with an illustrative embodiment. Data processing system 2100 can be used to implement cloud computing nodes 110 in FIG. 1, personal digital assistant (PDA) or smart phone 120A, desktop computer 120B, laptop computer 120C, and/or automobile computer system 120N in FIG. 1. Data processing system 2100 can be used to implement computers in hardware and software layer 202 in FIG. 2 as well as server computer 304, server computer 306, and client devices 310 in FIG. 3. Data processing system 1600 can also be used to implement computer system 406 in FIG. 4. In this illustrative example, data processing system 1600 includes communications framework 1602, which provides communications between processor unit 1604, memory 1606, persistent storage 1608, communications unit 1610, input/output (I/O) unit 1612, and display 1614. In this example, communications framework 1602 takes the form of a bus system.

Processor unit 1604 serves to execute instructions for software that can be loaded into memory 1606. Processor unit 1604 includes one or more processors. For example, processor unit 1604 can be selected from at least one of a multicore processor, a central processor unit (CPU), a graphics processing unit (GPU), a physics processing unit (PPU), a digital signal processor (DSP), a network processor, or some other suitable type of processor. Further, processor unit 1604 can may be implemented using one or more heterogeneous processor systems in which a main processor is present with secondary processors on a single chip. As another illustrative example, processor unit 1604 can be a symmetric multi-processor system containing multiple processors of the same type on a single chip.

Memory 1606 and persistent storage 1608 are examples of storage devices 1616. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1616 may also be referred to as computer-readable storage devices in these illustrative examples. Memory 1606, in these examples, can be, for example, a random-access memory or any other suitable volatile or non-volatile storage device. Persistent storage 1608 may take various forms, depending on the particular implementation.

For example, persistent storage 1608 may contain one or more components or devices. For example, persistent storage 1608 can be a hard drive, a solid-state drive (SSD), a flash memory, a rewritable optical disk, a rewritable magnetic tape, or some combination of the above. The media used by persistent storage 1608 also can be removable. For example, a removable hard drive can be used for persistent storage 1608.

Communications unit 1610, in these illustrative examples, provides for communications with other data processing systems or devices. In these illustrative examples, communications unit 1610 is a network interface card.

Input/output unit 1612 allows for input and output of data with other devices that can be connected to data processing system 1600. For example, input/output unit 1612 may provide a connection for user input through at least one of a keyboard, a mouse, or some other suitable input device. Further, input/output unit 1612 may send output to a printer. Display 1614 provides a mechanism to display information to a user.

Instructions for at least one of the operating system, applications, or programs can be located in storage devices 1616, which are in communication with processor unit 1604 through communications framework 1602. The processes of the different embodiments can be performed by processor unit 1604 using computer-implemented instructions, which may be located in a memory, such as memory 1606.

These instructions are referred to as program instructions, computer usable program instructions, or computer-readable program instructions that can be read and executed by a processor in processor unit 1604. The program instructions in the different embodiments can be embodied on different physical or computer-readable storage media, such as memory 1606 or persistent storage 1608.

Program instructions 1618 is located in a functional form on computer-readable media 1620 that is selectively removable and can be loaded onto or transferred to data processing system 1600 for execution by processor unit 1604. Program instructions 1618 and computer-readable media 1620 form computer program product 1622 in these illustrative examples. In the illustrative example, computer-readable media 1620 is computer-readable storage media 1624.

Computer-readable storage media 1624 is a physical or tangible storage device used to store program instructions 1618 rather than a medium that propagates or transmits program instructions 1618. Computer readable storage media 1624, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1618 can be transferred to data processing system 1600 using a computer-readable signal media. The computer-readable signal media are signals and can be, for example, a propagated data signal containing program instructions 1618. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1620” can be singular or plural. For example, program instructions 1618 can be located in computer-readable media 1620 in the form of a single storage device or system. In another example, program instructions 1618 can be located in computer-readable media 1620 that is distributed in multiple data processing systems. In other words, some instructions in program instructions 1618 can be located in one data processing system while other instructions in program instructions 1618 can be located in one data processing system. For example, a portion of program instructions 1618 can be located in computer-readable media 1620 in a server computer while another portion of program instructions 1618 can be located in computer-readable media 1620 located in a set of client computers.

The different components illustrated for data processing system 1600 are not meant to provide architectural limitations to the manner in which different embodiments can be implemented. In some illustrative examples, one or more of the components may be incorporated in or otherwise form a portion of, another component. For example, memory 1606, or portions thereof, may be incorporated in processor unit 1604 in some illustrative examples. The different illustrative embodiments can be implemented in a data processing system including components in addition to or in place of those illustrated for data processing system 1600. Other components shown in FIG. 16 can be varied from the illustrative examples shown. The different embodiments can be implemented using any hardware device or system capable of running program instructions 1618.

Thus, illustrative embodiments of the present invention provide a computer implemented method, computer system, and computer program product for processing a search query. A number of processor units selects an access path from access paths for each database in a set of databases based on reducing a cost for searching the set of databases using a set of access paths selected for the set of databases in response to receiving the search query from a requestor. The number of processor units receives a result set from searching the set of databases using a set of access paths selected for the set of databases. The number of processor units removes a number of duplicate records from records in the result set. The number of processor units sends the result set with the number of duplicate records removed to the requestor.

One or more illustrative examples can reduce the cost for searching databases. In one or more illustrative examples, and network cost is taken into account in processing the search query. One or more illustrative examples can take into account the network cost in network paths used to perform the search. Additionally, one more illustrative examples can remove duplicate records returned in a result set from searching databases. Further, one or more illustrative examples can use an expression in place of values in a column. With one or more of these different illustrative examples, the cost for processing a search query can be reduced when taking into account the network cost. The performance for computer system implementing one more illustrative examples can be improved. This improvement from the perspective of the requestor can be an increase in speed in receiving result sets from submitting search queries.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, To the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for processing a search query, the computer implemented method comprising:
selecting, by a number of processor units, an access path from access paths for each database in a set of databases based on reducing a cost for searching the set of databases using a set of access paths selected for the set of databases in response to receiving the search query from a requestor;
receiving, by the number of processor units, a result set from searching the set of databases using the set of access paths selected for the set of databases;
removing, by the number of processor units, a number of duplicate records from records in the result set; and
sending, by the number of processor units, the result set with the number of duplicate records removed to the requestor.

2. The computer implemented method of claim 1 further comprising:
marking, by the number of processor units, the result set to indicate a removal of the number of duplicate records in the result set to send to the requestor.

3. The computer implemented method of claim 2, wherein the result set comprises rows for the records and columns for attributes, wherein marking, by the number of processor units, the result set to indicate the removal of the number of duplicate records in the result set comprises:
adding, by the number of processor units, a duplication column to the result set; and
indicating, by the number of processor units, the number of duplicate records removed in the duplication column for the records with the number of duplicate records removed.

4. The computer implemented method of claim 2 further comprising:
merging, by the number of processor units, tables in the result set.

5. The computer implemented method of claim 2 further comprising:
calculating, by the number of processor units, a first cost for the result set in which the number of duplicate records is removed and marking is performed, wherein the first cost takes into account an input/output cost and a central processor unit cost;
calculating, by the number of processor units, a second cost for the result set in which duplicate records are not removed and marking is not performed, wherein the second cost takes into account the input/output cost, the central processor unit cost, and a network cost; and
returning, by the number of processor units, the result set in which the number of duplicate records is not removed and marking is not performed to the requestor instead of the result set in which the number of duplicate records is removed and marking is performed if the second cost less than or equal to the first cost.

6. The computer implemented method of claim 1, wherein sending, by the number of processor units, the result set with the number of duplicate records removed to the requestor comprises:
sending, by the number of processor units, the result set with the number of duplicate records removed over a network to the requestor, wherein a network cost is reduced for sending the result set with the number of duplicate records removed over the network as compared to sending the result set without the number of duplicate records removed.

7. The computer implemented method of claim 1 further comprising:
replacing, by the number of processor units, a value in a record in the result set with an expression indicating a relationship of the value with a set of other values in the record, wherein the expression reduces a size of the result set sent to the requestor.

8. The computer implemented method of claim 1, wherein the result set has a style comprising one of an in order result set, almost in order result set, and a disorder result set.

9. A computer system comprising:
comprising a number of processor units, wherein the computer system executes program instructions to:
select an access path from access paths for each database in a set of databases based on reducing a cost for searching the set of databases using a set of access paths selected for the set of databases in response to receiving the search query from a requestor;
receive a result set from searching the set of databases using the set of access paths selected for the set of databases;
remove a number of duplicate records from records in the result set; and
send the result set with the number of duplicate records removed to the requestor.

10. The computer system of claim 9, wherein the computer system executes the program instructions to:
mark the result set to indicate a removal of the number of duplicate records in the result set to send to the requestor.

11. The computer system of claim 10, wherein the result set comprises rows for the records and columns for attributes, wherein in marking the result set to indicate the removal of the number of duplicate records in the result set, the computer system executes the program instructions to:
add a duplication column to the result set; and
indicate the number of duplicate records removed in duplication column for the records with duplications.

12. The computer system of claim 10, wherein the computer system executes the program instructions to:
merge tables in the result set.

13. The computer system of claim 10, wherein the computer system executes the program instructions to:
calculate a first cost for the result set in which the number of duplicate records is removed and marking is performed; wherein the first cost takes into account an input/output cost and a central processor unit cost;
calculate a second cost for the result in which the number of duplicate records is not removed and marking is not performed, wherein the second cost takes into account the input/output cost, the central processor unit cost, and a network cost; and
return the result set in which the of number of duplicate records is not removed and marking is not performed to the requestor instead of the result set in which the number of duplicate records is removed and marking is performed if the second cost less than or equal to the first cost.

14. The computer system of claim 9 wherein in sending the result set with the number of duplicate records removed to the requestor, the computer system executes program instructions to:
send the result set with the number of duplicate records removed over a network to the requestor, wherein a network cost is reduced for sending the result set with the number of duplicate records removed over the network as compared to sending the result set without the number of duplicate records removed.

15. The computer system of claim 10, wherein the computer system executes the program instructions to:
replace a value in a record in the result set with an expression indicating a relationship of the value with a set of other values in the record, wherein the expression reduces a size of the result set sent to the requestor.

16. The computer system of claim 10, wherein the result set has a style comprising one of an in order result set, almost in order result set, and a disorder result set.

17. A computer program product for processing a search query, the computer program product comprising a computer readable storage medium having program instructions embodied therewith, the program instructions executable by a computer system to cause the computer system to perform a method of:
selecting, by a number of processor units, an access path from access paths for each database in a set of databases based on reducing a cost for searching the set of databases using a set of access paths selected for the set of databases in response to receiving the search query from a requestor;
receiving, by the number of processor units, a result set from searching the set of databases using the set of access paths selected for the set of databases;
removing, by the number of processor units a number of duplicate records from records in the result set; and
sending, by the number of processor units, the result set with the number of duplicate records removed to the requestor.

18. The computer program product of claim 17 further comprising:
marking, by the number of processor units, the result set to indicate the number of duplicate records for the records in the result set to send to the requestor.

19. The computer program product of claim 18, wherein the result set comprises rows for the records and columns for attributes, wherein marking, by the number of processor units, the result set to indicate a removal of the number of duplicate records in the result set comprises:
adding, by the number of processor units, a duplication column to the result set; and
indicating, by the number of processor units, the number of duplicate records removed in the duplication column for the records with the number of duplicate records removed.

20. The computer program product of claim 17 further comprising:
merging, by the number of processor units, tables in the result set.
